(19) United States
(12) Patent Application Publication
(10) Pub. No.: US 2010/0303286 A1
(43) Pub. Date: Dec. 2, 2010

(54) APPARATUS AND METHOD FOR IDENTIFYING LOCATION INFORMATION IN A PORTABLE TERMINAL

(75) Inventor: Jung-Tae KIM, Gyeonggi-do (KR)

Correspondence Address: Cha & Reiter, LLC, 17 Arcadian Avenue, Suite 208, Paramus, NJ, 07652, US

(73) Assignee: SAMSUNG ELECTRONICS CO., LTD., Gyeonggi-Do (KR)

(21) Appl. No.: 12/787,720

(22) Filed: May 26, 2010

(30) Foreign Application Priority Data
May 26, 2009 (KR) 10-2009-0046086

(51) Int. Cl. G06K 9/00

(52) U.S. Cl. 382/100; 382/190

(57) ABSTRACT

An apparatus and method for determining location information of a subject included in an image, using the image in a portable terminal not having a function of acquiring location information such as a Global Positioning System (GPS) function. The apparatus includes a controller for processing to request location information through an image and receive the location information on the image from an image search server storing a plurality of images having location information therein.

### CLAIM OF PRIORITY

This application claims the benefit of priority, under 35 U.S.C. §119(a), of a Korean patent application filed in the Korean Intellectual Property Office on May 26, 2009 and assigned Serial No. 10-2009-0046086, the entire disclosure of which is hereby incorporated by reference in its entirety.

### BACKGROUND OF THE INVENTION

1. Field of the Invention

The present invention relates to an apparatus and method for determining location information in a portable terminal. More particularly, the present invention relates to an apparatus and method for determining location information of a subject included in an image, and using the image in a portable terminal not having a positioning function such as a Global Positioning System (GPS) function.

2. Description of the Related Art

In recent years, with the rapid development of portable terminals, in particular portable terminals with wireless voice data information exchange capabilities, such portable terminals have become necessities of modern life. In the early stages of development, the portable terminals were simply recognized as being portable telephones and made a wireless call possible. However, with the development of a number of technologies, as well as the introduction of the wireless Internet, the portable terminal's utility has significantly increased in scope. For example, the increased functionality of portable terminals include important items such as photographing an image by an equipped digital camera, viewing satellite broadcasting, playing a game, remote control using a local area communication, tracking a user location, etc., as well as simple telephony, schedule management, just to name some possibilities.

Among the increase in functionality, the user location tracking is an important function usable when determining a location of a user who encounters emergency using a portable terminal. The user location tracking permits a determination of a location of a user who encounters an emergency, thus providing a great deal of help for saving lives.

The user location tracking is an example of a location-based service. In order to determine a location of a user using a portable terminal, the user location tracking generally uses a method of receiving a satellite signal by way of a GPS function and measuring a location of the portable terminal.

The method of receiving the satellite signal and measuring the location of the portable terminal has an advantage of making an accurate location determination through satellite signal reception possible; however, there is a problem in that a separate device for receiving the satellite signal results in an increased cost of the portable terminal.

Thus, in order to solve the above problem, there is a need in the art for an apparatus and method for determining a current location in a portable terminal that is not equipped with a separate device for receiving a satellite signal.

### SUMMARY OF THE INVENTION

An exemplary aspect of the present invention is to provide an apparatus and method for determining location information in a portable terminal that is unable to receive the location information, for example, such as by a satellite.

Another exemplary aspect of the present invention is to provide an apparatus and method for determining location information through an image content-based search in a portable terminal that is unable to receive the location information.

The above and other exemplary aspects are achieved by providing an apparatus and method for determining location information in a portable terminal.

In accordance with an exemplary aspect of the present invention, an apparatus for determining location information in a portable terminal includes a controller for processing requested location information through an image, and for receiving the location information on the image from an image search server storing a plurality of images comprising location information.

In accordance with yet another exemplary aspect of the present invention, an apparatus for providing location information in an image search server is provided. The apparatus includes a server controller. Upon receiving a location information request through an image, the server controller sorts the same candidate images as the image and transmits the sorted candidate images to a portable terminal. Upon receiving information on the same final image as the image whose location information has been requested from the portable terminal, the server controller determines location information corresponding to the final image and transmits the location information to the portable terminal.

According to a further exemplary aspect of the present invention, a method for determining location information in a portable terminal is provided. The method preferably includes requesting location information through an image, and receiving the location information on the image from an image search server storing a plurality of images comprising location information.

According to a yet another exemplary aspect of the present invention, a method for providing location information in an image search server is provided. The method preferably includes, upon receiving a location information request through an image, sorting the same candidate images as the image and transmitting the sorted candidate images to a portable terminal and, upon receiving information on the same final image as the image whose location information has been requested from the portable terminal, determining location information corresponding to the final image and transmitting the location information to the portable terminal.

According to a still another exemplary aspect of the present invention, a mobile communication system for providing location information preferably includes a portable terminal and an image search server. The portable terminal requests location information through an image and receives the location information on the image. Upon receiving the location information request from the portable terminal, the image search server determines the location information corresponding to the image whose location information has been requested from among a plurality of previously stored images.

### BRIEF DESCRIPTION OF THE DRAWINGS

The above and other exemplary objects, features and advantages of the present invention will become more apparent from the following detailed description when taken in conjunction with the accompanying drawings in which:

FIG. 1 is a block diagram illustrating a construction of a mobile communication system according to the present invention for making location information determination possible in a portable terminal unable to receive a satellite signal;

FIG. 2 is a flowchart illustrating an exemplary operational process of acquiring location information in a portable terminal unable to receive a satellite signal according to the present invention;

FIG. 3 is a flowchart illustrating an exemplary operational process of acquiring location information in a portable terminal according to an exemplary embodiment of the present invention;

FIG. 4 is a flowchart illustrating an exemplary operational process of providing location information in an image search server according to an exemplary embodiment of the present invention; and

FIG. 5 is a ladder diagram illustrating an exemplary operational process of providing location information to a portable terminal, which is unable to receive a satellite signal, in a mobile communication system according to an exemplary embodiment of the present invention.

### DETAILED DESCRIPTION

The following description, with reference to the accompanying drawings, is provided for illustrative purposes to assist a person of ordinary skill in the art with a comprehensive understanding of certain exemplary embodiments of the invention provided herein. The description includes various specific details to assist a person of ordinary skill the art with understanding the claimed invention, but these details are to be regarded as merely exemplary. Accordingly, those of ordinary skill in the art will recognize that various changes and modifications of the illustrative examples described herein can be made without departing from the spirit of the invention and the scope of the appended claims. Also, descriptions of well-known functions and constructions may be omitted for clarity and conciseness when their inclusion may obscure appreciation of the subject matter of the claimed invention by a person of ordinary skill in the art.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustrative purposes only and not for the purpose of limiting the invention as defined by the appended claims and their equivalents.

It is to be understood that the singular forms “a,” “an,” and “the” include plural references unless the context clearly dictates otherwise. Thus, for example, a reference to “a component surface” includes reference to one or more of such surfaces.

By the term “substantially” it is typically meant that the recited characteristic, parameter, or value need not be achieved exactly, but that deviations or variations, including but in no way limited to, for example, tolerances, measurement error, measurement accuracy limitations and other factors known to persons of ordinary skill in the art, may occur in amounts that do not preclude the effect the characteristic was intended to provide.

The following description is made for an apparatus and method for using a location information based service in a portable terminal not having a function of acquiring location information such as a Global Positioning System (GPS) function.

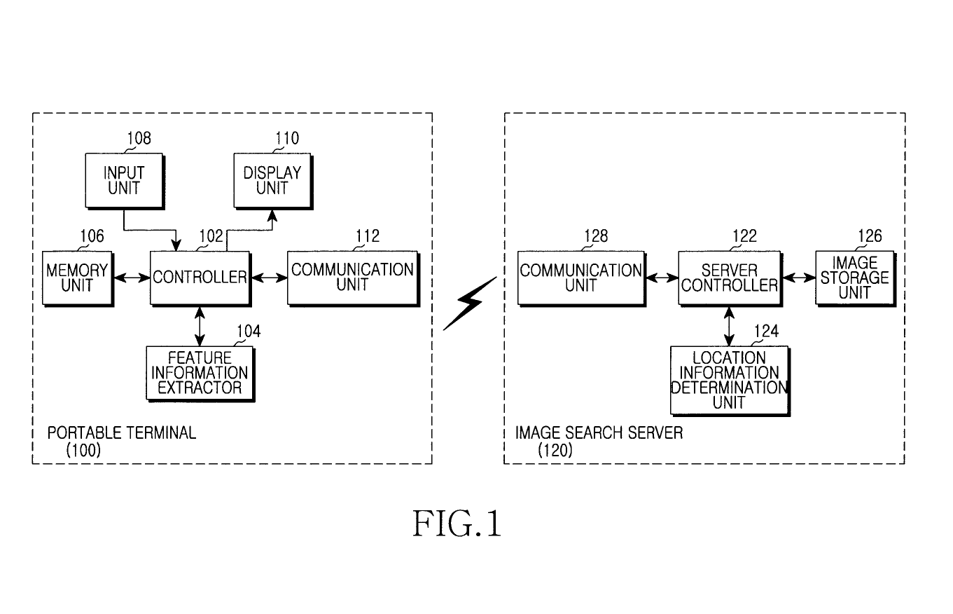

FIG. 1 is a block diagram illustrating a construction of a mobile communication system for making location information determination possible in a portable terminal impossible to receive a satellite signal according to the present invention.

Referring to FIG. 1, the mobile communication system may include a portable terminal 100 and an image search server 120.

The portable terminal 100 may include a controller 102, a feature information extractor 104, a memory unit 106, an input unit 108, a display unit 110, and a communication unit 112. The controller 102 typically controls a general operation of the portable terminal 100. For example, the controller 102 performs processing and control for voice telephony and data communication. In addition to a general function, according to the present invention, the controller 102 processes to, after sending a request for location information corresponding to an image to the image search server 120, receive the location information according to the request from the image search server 120.

In more detail, after acquiring an image for location information determination, the controller 102 controls extraction of the acquired image or feature information of the acquired image and transmits the extracted image or feature information to the image search server 120.

After performing the above operation, in the case where the controller 102 receives candidate images from the image search server 120, the controller 102 determines if a user selects the same final image as an image intended to determine location information from among the candidate images, transmit selected final image information to the image search server 120, and receives location information on the image from the image search server 120.

Under the instruction of the controller 102, the feature information extractor 104 processes the extraction of specific elements being features of the acquired image.

For example, in the case where a user of the portable terminal 100 intends to determine location information using an image of a specific church, the feature information extractor 104 extracts feature information such as a cross of the church, a name and phone number of the church, etc. By doing so, the feature information extractor 104 can better reduce a use resource by such feature extraction than when the portable terminal 100 transmits the whole image to the image search server 120.

The memory unit 106 preferably includes, for example, storage such as a Read Only Memory (ROM), a Random Access Memory (RAM), a flash ROM, and the like, just to name some possible examples. The ROM stores a microcode (i.e., code) of a program for processing and controlling the controller 102 and the feature information extractor 104 and a variety of kinds of reference data.

The RAM serves as a working memory of the controller 102, and stores temporary data generated during execution of a variety of kinds of programs. The flash ROM stores various kinds of updateable depository data such as a phone book, an outgoing message, an incoming message, and the like.

The input unit 108 preferably includes numeral key buttons ‘0’ to ‘9’, a menu button, a cancel button, an OK button, a talk button, an end button, an Internet button, navigation key (or direction key) buttons, a plurality of function keys such as a character input key, and the like. The input unit 108 provides key input data corresponding to a key pressed by a user to the controller 102.

The display unit 110 displays state information generated during operation of the portable terminal, such as a limited number of characters, a large amount of moving pictures, still pictures, and the like. The display unit 110 may be a color Liquid Crystal Display (LCD), Active Mode Organic Light Emitting Diode (AMOLED), and the like. Virtually any type of thin film screen technology can be used with the present invention. The display unit 110 may include a touch input device and, in the case of applying to a portable terminal of a touch input scheme, the display unit 110 can be used as an input device.

The communication unit 112 transmits/receives and processes a radio signal of data, which is input/output through an antenna (not shown). For example, in a transmission mode, the communication unit 112 processes original data through channel coding and spreading, converts the original data into a Radio Frequency (RF) signal, and transmits the RF signal. In a reception mode, the communication unit 112 converts a received RF signal into a baseband signal, processes the baseband signal through de-spreading and channel decoding, and restores the signal to original data. A person of ordinary skill in the art understands and appreciates that the claimed invention is not limited to a spread spectrum protocol for the communication unit 112.

With continued reference to FIG. 1, the image search server 120 can include a server controller 122, a location information determination unit 124, an image storage unit 126, and a communication unit 128. The server controller 122 performs a general operation of the image search server 120. According to the present invention, in the case where the server controller 122 receives an image or feature information of the image from the portable terminal 100, the server controller 122 processes the search an image requested by the portable terminal 100 from among a plurality of previously stored images and determine corresponding location information.

In more detail, in a case where the server controller 122 receives an image for determination of a location of a subject included in the image or feature information of the image from the portable terminal 100, the server controller 122 controls sorting of candidate images according to a candidate image search scope and the transmitting of the sorted candidate images to the portable terminal 100.

After transmitting of the sorted candidate images to the portable terminal 100, the server controller 122 receives information on a final image, which a user selects among the candidate images, from the portable terminal 100. In this case, the server controller 122 controls a process of determining location information included in the final image and providing the location information to the portable terminal 100.

Under the instruction of the server controller 122, the location information determination unit 124 preferably acquires location information from a final image received from the portable terminal 100. Here, the location information represents a location of a subject of the final image.

The image storage unit 126 preferably stores a microcode of a program for processing and control of the image search server 120 and various kinds of reference data. According to the present invention, the image storage unit 126 stores a plurality of images including information on locations of subjects of the images.

The communication unit 128 of the image search sever 128 communicates with the portable terminal 100 to determine location information and transmits/receives data for location information provision.

A function of the feature information extractor 104 of the portable terminal 100 can be implemented by the controller 102 of the portable terminal 100. However, while these items are separately constructed and shown in the present invention as an exemplary construction for description convenience, and does not limit the scope of the present invention. It will be understood and appreciated by those skilled in the art that various modifications of construction can be made within the scope of the present invention. For example, construction can also be such that some/all of the functions shown as discrete modules are processed in the controller 102.

The following description entails a method for using a location information based service in a portable terminal not having a function of acquiring location information, using the apparatus according to the exemplary embodiment of the present invention.

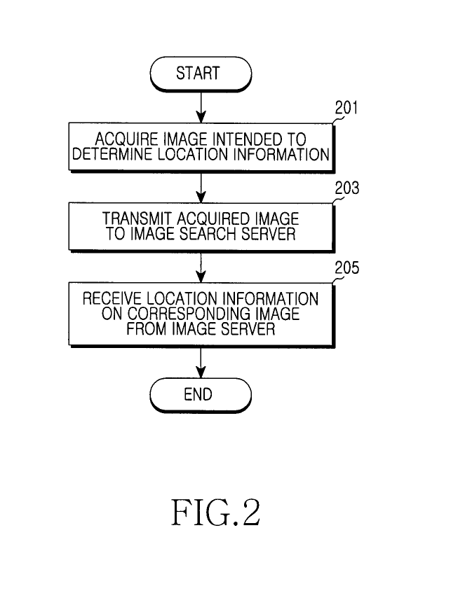

FIG. 2 is a flowchart illustrating a process of acquiring location information in a portable terminal unable to receive a satellite signal according to the present invention.

Referring now to FIG. 2, in step 201, the portable terminal 100 acquires an image of an area intended to determine location information. Here, the portable terminal 100 performs a process of acquiring the image by capturing an image intended to acquire location information or selecting one of previously stored images.

At step 203, the portable terminal 100 proceeds transmits the acquired image of step 201 to an image search server 120, such as shown in FIG. 1. Here, the image search server 120 manages an image including information on a location of a subject, and can provide a geo-tagging service. Due to the geo-tagging, the image search server 120 can search the same image as the image received from the portable terminal 100 from among a plurality of previously stored images, determine location information included in the searched image, and provide the determined location information to the portable terminal 100.

In addition, the portable terminal 100 can process sending an image itself to the image server 120, or may extract and transmit feature information representing a feature of the image to the image server 120.

Here, the portable terminal extracting and transmitting the feature information of the image to the image search server 120 can more save resources than transmitting the image itself to the image search server 120.

Then, at step 205, the portable terminal 100 receives location information on a corresponding image from the image search server 120.

After that, the portable terminal 100 terminates the process according to the exemplary embodiment of the present invention.

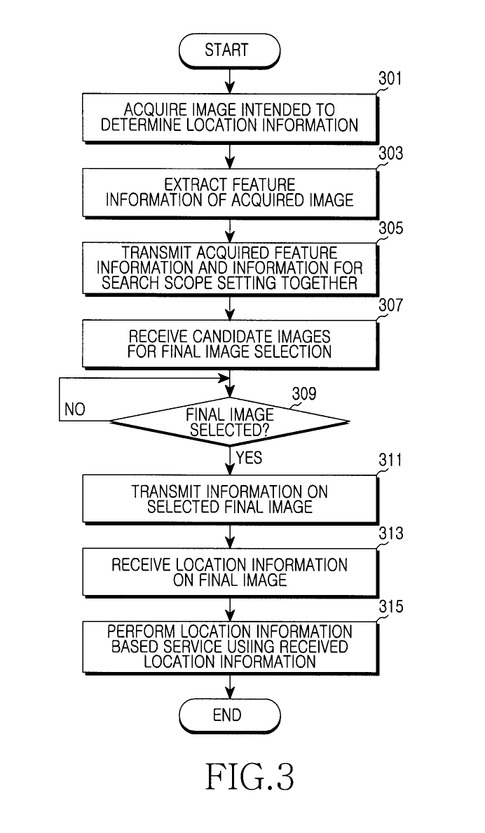

FIG. 3 is a flowchart illustrating a process of acquiring location information in a portable terminal according to an exemplary embodiment of the present invention.

In FIG. 3, the portable terminal 100 represents a portable terminal unable to receive a satellite signal.

In order to acquire location information on a specific area, in step 301, the portable terminal 100 selects an image corresponding to an area intended to determine location information. Here, the portable terminal 100 can perform a process of acquiring the image of step 301 by capturing an image intended to acquire location information, or by selecting one of previously stored images as in step 201 of FIG. 2 described herein above.

At step 303, the portable terminal 100 extracts feature information of the acquired image of step 301. Then, at step 305, the portable terminal 100 transmits the acquired feature information and search scope setting information to the image search server 120 together. Here, the search scope setting information comprises information for setting a scope for searching an image, which a user desires, among a plurality of images stored in the image search server 120. For example, the portable terminal 100 can set information of an area in which a subject of the image is located and transmits the information to the image search server 120. Alternative, the portable terminal can transmit the information to a Base Station (BS) can transmit BS information capable of informing an area in which the portable terminal 100 is located, to the image search server 120.

Then, at step 307, the portable terminal 100 receives candidate images for final image selection from the image search server 120. Then, at step 309, the portable terminal 100 determines if the user selects a final image (i.e., the image of the area intended to determine the location information) from the candidate images.

Here, the candidate images are images similar to the image that the portable terminal 100 acquires in step 301, i.e., the image which the user intends to determine the location information. The image search server 120 can search, for example, for the candidate images from among previously stored images by using the feature information of the image received from the portable terminal 100.

If the portable terminal determines at step 309 that the user does not select the final image, the portable terminal 100 again performs the process of step 309 until the final image is selected.

On the other hand, if determining that the user selects the final image in step 309, the portable terminal proceeds to step 311 and transmits information on the final image selected by the user to the image search server 120. Then, at step 313 the portable terminal receives location information on the final image from the image search server 120.

At step 315, the portable terminal performs a location information based service using the received location information. After that, the portable terminal terminates the process according to the exemplary embodiment of the present invention.

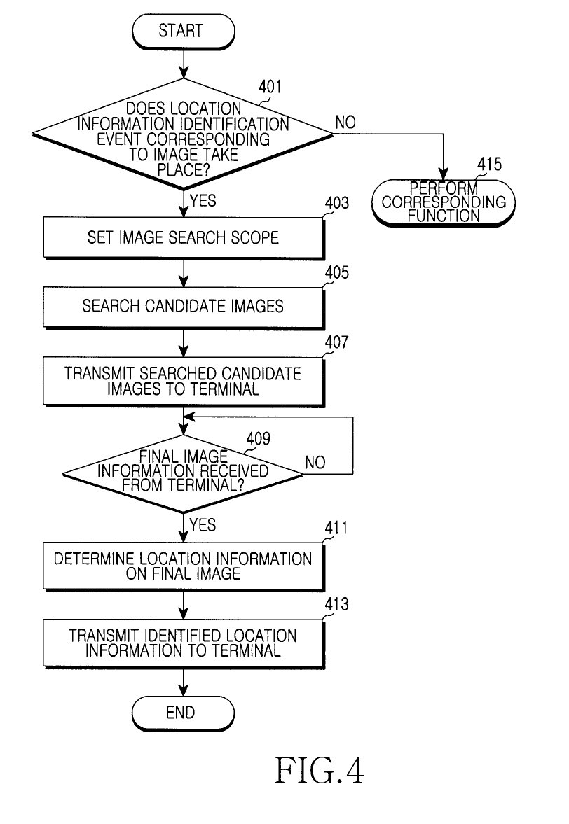

FIG. 4 is a flowchart illustrating exemplary operation of a process of providing location information in an image search server according to an exemplary embodiment of the present invention.

Referring now to FIG. 4, at step 401, the image search server 120 determines whether or not a location information determination event corresponding to an image takes place. Here, the location information determination event corresponding to the image refers to circumstances in which a portable terminal 100 receives an image corresponding to an area intended to determine or feature information of the image.

After determining at step 401 that the location information determination event corresponding to the image does not take place, the image search server 120 proceeds to step 415 and performs a corresponding function.

On the other hand, if determining at step 401 that the location information determination event corresponding to the image occurs, at step 403 the image search server 120 sets an image search scope. Here, in order to set the image search scope, the image search server 120 can receive information for setting the image search scope (e.g., information on a scope restricted to a town, a province, and a county) or can receive information from the BS regarding a BS of an area in which the portable terminal 100 is located.

At step 405, the image search server 120 searches candidate images, which are similar with a received image of a specific area or feature information of the image. Then, at step 407, the image search server 120 transmits the chosen candidate images to the portable terminal 100.

Here, the candidate images are images similar with an image corresponding to a location, from which the portable terminal 100 intends to determine the location. The image search server 120 can search the candidate images from among previously stored images using the feature information of the image received from the portable terminal 100.

Then at step 409, the image search server 120 and determines if it receives information on a final image selected by a user, (i.e., an image corresponding to an area, which the user intends to determine) from the portable terminal 100.

If the image server has not received the information from the terminal regarding the final image in step 409, the image search server 120 repeats performance of step 409.

On the other hand, if at 409 receiving the information on the final image, then at step 411 the image search server 120 determines location information regarding the final image. At this time, the image search server 120, which is a server capable of providing a geo-tagging service, can perform the process by determining geo-tagging information included in the final image.

At step 413, the image search server 120 transmits the determined location information on the final image to the portable terminal 100. After that, the image search server 120 terminates the process according to the exemplary embodiment of the present invention.

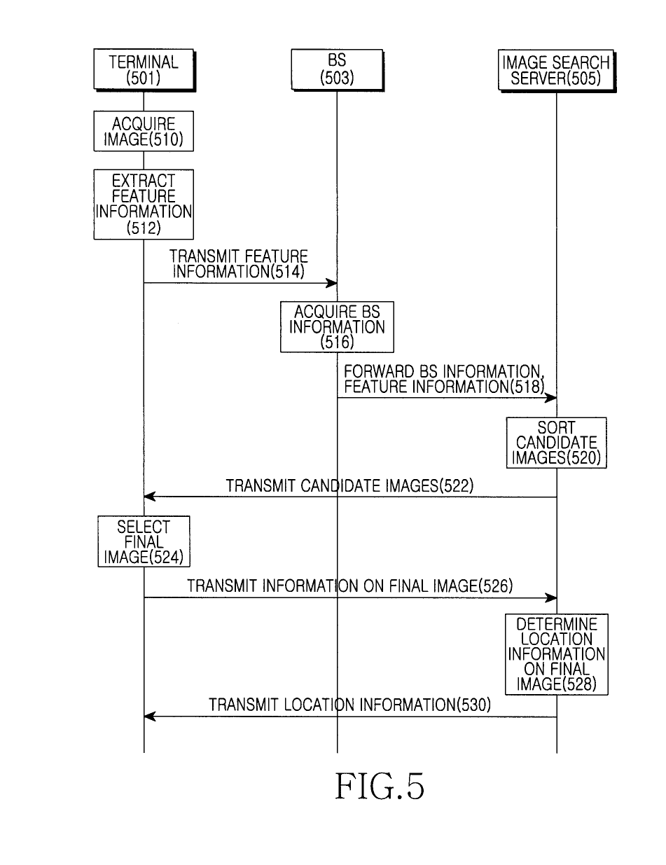

FIG. 5 is a ladder diagram illustrating a process of providing location information to a portable terminal in a mobile communication system according to an exemplary embodiment of the present invention. Similar to the other exemplary embodiments, the portable terminal in this exemplary embodiment is unable to receive satellite signals for determining a location.

In FIG. 5, the mobile communication system preferably includes a terminal 501, a BS 503, and an image search server 505.

Referring now to FIG. 5, at step 510, the terminal 501 acquires an image intended to determine location information. Then, at step 512, the terminal 501 extracts feature information on the image in order to request location information of the acquired image. Here, the terminal 501 does not transmit the whole image, but rather transmits feature information representing a feature of the image to request the location information, for the sake of saving resources in a location information request process.

At step 514, the terminal 501 transmits the acquired feature information to the BS 503 to perform a location information request process using an image.

For example, in case that a user of the terminal 501 intends to determine location information by using an image of a specific church, the terminal 501 will extract feature information such as a cross of the church, a name and phone number of the church, etc. and transmits the extracted feature information to the BS 503.

At step 516, upon receiving the location information request from the terminal 501, the BS 503 acquires BS information, which is information for informing an area in which the terminal 501 is located.

At step 518, the BS 503 forwards the BS information and the feature information to the image search server 505.

At step 520, upon receiving the above information, the image search server 505 sets a search scope and sorts candidate images among a plurality of previously stored images. For example, in case that the image search server 505 receives BS information ‘A’ from the BS 503, the image search server 505 can sort images included in an area corresponding to the BS information ‘A’ and, after that, sort candidate images including the feature information of the image received from the terminal 501 (e.g., church pictures included in the area corresponding to the BS information ‘A’). After that, the image search server 505 gives a weight to the set search scope. By doing so, the image search server 505 can reduce the number of the candidate images matching with the feature information of the image received from the terminal 501.

Then, at step 522, the image search server 505 transmits the sorted candidate images to the terminal 501. Upon receiving the candidate images, the terminal 501 determines if the image intended to determine location information is included among the candidate images.

If determining that the image intended to determine the location information is included among the candidate images, at step 524 the terminal 501 performs a final image selection process of selecting the image intended to determine location information among the candidate images.

At step 526, the terminal 501 transmits information on the selected final image to the image search server 505.

After receiving the information on the selected final image from the terminal 501, at step 528 the image search server 505 determines location information on the final image. Then, at step 530, the image search server 505 transmits the determined location information to the terminal 501. By transmitting the determined location information, the terminal 501, which is unable to receive a satellite signal, can acquire location information, by being provided with a location information based service.

As described above, in order to make location information determination possible, an exemplary embodiment of the present invention allows a portable terminal not having a function of acquiring location information to transmit an image of a location intended to determine, to a server managing an image including location information of a corresponding area and then receive location information on the image. By this, the portable terminal not equipped with a device for location information reception can be provided with a location information based service.

The above-described methods according to the present invention can be realized in hardware or as software or computer code that can be stored in a recording medium such as a CD ROM, an RAM, a floppy disk, a hard disk, or a magneto-optical disk or downloaded over a network and stored on the aforementioned, so that the methods described herein can be rendered in such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer is loaded with, or accesses, code that may be stored in a memory component, the general purpose computer is transformed into a special purpose computer suitable for at least executing and implementing the processing shown herein.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An apparatus for determining location information in a portable terminal, the apparatus comprising a controller for processing requested location information using an image and for receiving the location information associated with the image from an image search server storing a plurality of images respectively comprising location information.

2. The apparatus of claim 1, wherein, after acquiring an image of an area as a basis to determine location information, the controller extracts an entirety of the acquired image and requests the location information.

3. The apparatus of claim 1, wherein, after acquiring an image of an area as a basis to determine location information, the controller extracts feature information of the acquired image and requests the location information.

4. The apparatus of claim 2, wherein the controller transmits information for setting a scope for searching an image which a user desires, from among the plurality of images stored in the image search server, to request the location information based on the acquired image.

5. The apparatus of claim 3, wherein the controller transmits information for setting a scope for searching an image which a user desires, from among the plurality of images stored in the image search server, to request the location information based on the extracted feature information of the acquired image.

6. The apparatus of claim 1, wherein the controller receives candidate images for final image selection corresponding to the location information request through the image, selects a final image among the candidate images, transmits information on the selected final image to the image search server, and receives location information on the final image from the image search server.

7. An apparatus for providing location information in an image search server, the apparatus comprising a server controller for, upon receiving a location information request using an image, sorting a plurality of candidate images substantially corresponding to the image received as a basis for the location information request, and for transmitting the sorted candidate images to a portable terminal and, upon receiving information from the portable terminal regarding a same final image selected from among the candidate images corresponding to the image whose location information has been requested from the portable terminal, the server controller determining location information corresponding to the same final image and transmitting the location information to the portable terminal.

8. The apparatus of claim 7, wherein the server controller sets an image search scope using information for setting a scope for searching an image that a user desires, from among a plurality of images stored in the image search server, and sorts the candidate images within the set image search scope.

9. The apparatus of claim 8, wherein the plurality of images stored in the image search server comprise information regarding a location of a subject comprised in the image.

10. A method for determining location information in a portable terminal, the method comprising:
requesting location information using an image provided as a reference; and
receiving the location information associated with the image from an image search server storing a plurality of images comprising location information.

11. The method of claim 10, wherein requesting the location information using the image as a reference further comprises:
acquiring an image of an area as a basis to determine location information; and
extracting one of the whole acquired image or feature information of the acquired image and requesting the location information.

12. The method of claim 11, wherein requesting the location information using the image provided as a reference further includes transmitting information for setting a scope for searching an image that a user desires, from among the plurality of images stored in the image search server.

13. The method of claim 10, wherein receiving the location information on the image further comprises:
receiving a plurality of candidate images for final image selection corresponding to the location information request using the image provided as a reference and selecting a final image from among the candidate images;
transmitting information to the image server identifying the selected final image; and
receiving location information from the image server associated with the selected final image.

14. A method for providing location information in an image search server, the method comprising:
upon receiving a location information request using an image as a reference, sorting a plurality of candidate images substantially corresponding to the image provided as a reference and transmitting the sorted candidate images to a portable terminal; and
upon receiving information from the portable terminal selected as a same final image as the image whose location information has been requested, determining location information corresponding to the selected final image and transmitting the location information to the portable terminal.

15. The method of claim 14, wherein sorting the candidate images substantially corresponding to the image provided as a reference and transmitting the sorted candidate images to the portable terminal further comprises:
setting an image search scope using information for setting a scope for searching an image that a user desires, from among a plurality of images stored in the image search server; and
sorting the candidate images within the set image search scope.

16. The method of claim 15, wherein the plurality of images stored in the image search server comprises information associated with a location of a subject comprised in the image.

17. A mobile communication system for providing location information, the system comprising:
a portable terminal for requesting location information through an image provided as a reference and for receiving the location information associated with the image; and
an image search server for, upon receiving the location information request from the portable terminal, determining the location information corresponding to the image whose location information has been requested among a plurality of previously stored images.

18. The apparatus according to claim 17, wherein the image search server comprises a base station communicating with the portable terminal via a spread spectrum protocol.

19. The apparatus according to claim 17, wherein the portable terminal and the image search server communicate via wireless communication.
